(19) United States
(12) Patent Application Publication
(10) Pub. No.: US 2016/0371930 A1
(43) Pub. Date: Dec. 22, 2016

(54) METHOD AND SYSTEM FOR PROVIDING A MULTI-LEVEL INCENTIVE

(71) Applicant: NHN Entertainment Corporation, Seongnam-si (KR)

(72) Inventor: Chuljae LIM, Seongnam-si (KR)

(21) Appl. No.: 15/183,994

(22) Filed: Jun. 16, 2016

(30) Foreign Application Priority Data
Jun. 16, 2015 (KR) 10-2015-0084878

(51) Int. Cl. G07F 17/32; G06Q 30/02

(52) U.S. Cl. CPC G07F 17/3255; G06Q 30/0209; G07F 17/323

(57) ABSTRACT

A method and system for improving the performance of an online game by providing a multi-level incentive when a game user transmits gift to a friend participating in the online game. The game users receive appropriate rewards by providing the incentive in multi-level, in which the first user in a chain of subsequent user gifts receives an reward repeatedly. Therefore, gift exchanges between games users are incented and the game play is enhanced by extending the reward range.

### CROSS REFERENCE TO RELATED APPLICATION

This application claims priority from and the benefit of Korean Patent Application No. 10-2015-0084878, filed on Jun. 16, 2015, which is hereby incorporated by reference for all purposes as if fully set forth herein.

### BACKGROUND

Field

Exemplary embodiments of the inventive concept relate to a method and system for providing a multi-level incentive to improve the performance of online gaming applications, and, more particularly, to a method and system for providing a multi-level incentive capable of providing a multi-level incentive to a first user terminal or user account associated with an online gaming application that has purchased a gift and sent the gift to a friend, who may also have a terminal or account associated with the online gaming application.

Discussion of the Background

Recently, mobile shopping, social network service (SNS), games, and like have been increased as the usage of smart phones are increasing. Also, sending electronic gifts represented by icons, commonly known as “Gifticons” to friends or acquaintances through smart phones has also been increased. In case of mobile game users, in general, communication between game users is promoted, intimacy between users is increased, and the performance of the game is enhanced by exchanging game items and contents between the game users.

Generally, actively purchasing and exchanging game items and contents between friends and acquaintances vitalizes a game and improves the motivation to play the game and to increase game levels among game users. In such cases, most of the gifts are purchased by existing points or digital currency, and a game user typically purchases the digital currency with a small amount of money to purchase items or contents. However, game users generally do not get any particular rewards or incentives associated with the purchase of the items or contents, unless special events and discounts are offered from the game server.

As described above, there is no compensation provided to game users who actively exchange items or contents with each other. Therefore, there is a need in the online gaming field to provide a proper reward plan incenting users to the exchange items or contents to enhance and improve game play.

The above information disclosed in this Background section is only for enhancement of understanding of the context of the inventive concepts, and, therefore, may contain information that does not form the prior art that is already known in this country to a person of ordinary skill in the art.

### SUMMARY

The invention meets the aforementioned needs in the art by providing an appropriate incentive to an online gamer for transmitting a gift or reward usable in an online game to a friend.

According to an exemplary embodiment of the invention, a method for improving the performance of an online game by providing an incentive to one or more user terminals used in the online game upon obtaining a gift from a game server includes receiving from a first user terminal a first gift request and a transmission request to send the first gift to a second user terminal, processing the first gift request and transmitting the first gift to the second user terminal, receiving from the second user terminal a second gift request and a transmission request to send the second gift to the first user terminal or a third user terminal, processing the second gift request and transmitting the second gift to the first user terminal or the third user terminal, and providing a first incentive corresponding to a characteristic of the first gift to the first user terminal.

The method may further include providing the first incentive corresponding to a characteristic of the second gift to the second user terminal.

The method may further include receiving from the third user terminal a third gift request and a transmission request to send the third gift to the second user terminal or a fourth user terminal, processing the third gift request and transmitting the third gift to the second user terminal or the fourth user terminal, and providing a second incentive corresponding to the characteristic of the first gift to the first user terminal and the first incentive corresponding to a characteristic of the second gift to the second user terminal.

The method may further include providing the first incentive corresponding to a characteristic of the third gift to the third user terminal.

The incentive may be provided to a game-mailbox or a game-media capable of receiving items associated with a user account.

The incentive may correspond to a portion of the values of the gift obtained and is saved as a reward credit.

The saved reward credit may not exceed a first percentage of the value of the gift.

The reward credit may be capable of being used to obtain items or join an online event hosted by the game server.

The reward credit may be capable of being used to obtain a portion of the value of the items.

According to an exemplary embodiment of the invention, an online gaming system for providing an incentive to one or more user terminals connected to a game server includes a gift receiving module configured to receive requests to transmit a first gift and a second gift to user terminals, a gift transmission processing module configured to process the requests to transmit the first gift and the second gift, and an incentive controlling module configured to provide an incentive in response to transmitting the first gift and the second gift when the first gift is obtained by a first user terminal and transmitted to a second user terminal, and the second gift is obtained by the second user terminal and transmitted to a third user terminal.

The incentive controlling module may be configured to save a first reward credit based upon a portion of the values of the first gift to the first user terminal.

The incentive controlling module may be configured to save a portion of the value of the first gift to the first user terminal as a first reward credit, and a portion of the value of the second gift to the second user terminal as the first reward credit.

The incentive controlling module may include a friend list controlling module configured to store friends lists stored in an address book of the user terminals, and the incentive controlling module may be configured to save a portion of the value of the first gift to the first user terminal as a first reward credit, when a third user of the third user terminal is stored in the address book of the first user terminal.

The gift receiving module may be configured to receive a request to transmits a third gift, the gift transmission processing module may be configured to process the request and transmit the third gift, and the incentive controlling module may be configured to provide the incentive corresponding to a characteristic of the third gift to the user terminals upon transmitting the third gift, when the third gift is obtained by the third user terminal and transmitted to the second user terminal or a fourth user terminal.

The incentive controlling module may be configured to save a portion of the value of the first gift to the first user terminal as a second reward credit, and a portion of the value of the second gift to the second user terminal as the first reward credit.

The gift receiving module may be configured to receive a request to send a third gift, the gift transmission processing module may be configured to process the request and transmit the third gift, and the incentive controlling module may be configured to provide a portion of the value of the first gift to the first user terminal as a second reward credit, a portion of the value of the second gift to the second user terminal as the second reward credit, and a portion of a value of the third gift to the third user terminal as the first reward credit, when the third gift is obtained by the third user terminal and transmitted to the second user terminal or a fourth user terminal.

The gift receiving module may be configured to receive a request to send a third gift, the gift transmission processing module may be configured to process the request and transmit the third gift to a fourth user terminal, and the incentive controlling module may be configured to provide a portion of the value of the first gift to the first user terminal as a second reward credit, and a portion of the value of the second gift to the second user terminal as the first reward credit, when a fourth user of the fourth user terminal is stored in the address book of the first user terminal and in the address book of the second user terminal.

According to an exemplary embodiment of the invention, a method for improving the performance of an online game by providing an incentive to one or more user terminals used in the online game upon obtaining a gift from a game server includes receiving from a first user terminal a first gift request and a transmission request to send the first gift to a second user terminal, processing the first gift request and transmitting the first gift to the second user terminal, receiving from the second user terminal a second gift request and a transmission request to send the second gift to a third user terminal, processing the second gift request and transmitting the second gift to the third user terminal, determining in a processor of the game server whether a third user of the third user terminal is registered as a friend of a first user of the first user terminal, providing the incentive corresponding to a characteristic of the first gift to the first user terminal as a first reward credit when the third user of the third user terminal is registered as a friend of the first user of the first user terminal.

Determining of the third user as the friend of the first user may be based on a friend list of the first user.

The friend list of the first user may include at least one friend stored in an address book of the first user terminal.

The method may further include receiving from the third user terminal a third gift request and a transmission request to send the third gift to a fourth user terminal, transmitting the third gift to the fourth user terminal, determining whether a fourth user of the fourth user terminal is registered as a friend of the first user of the first user terminal and a second user of the first user terminal, providing a portion of the value of the first gift to the first user terminal as a second reward credit, and a portion of the value of the second gift to the second user terminal as the first reward credit, if the fourth user of the third user terminal is registered as a friend of the first user of the first user terminal and the second user of the second user.

Determining of the fourth user of the fourth user terminal as a friend of the first user and the second user may be based on friend lists of the first user and the second user stored in the game server.

A friend list of the first user may include at least one friend stored in an address book of the first user terminal, and a friend list of the second user may include at least one friend stored in an address book of the second user terminal.

Additional aspects will be set forth in the detailed description which follows, and, in part, will be apparent from the disclosure, or may be learned by practice of the inventive concept.

The foregoing general description and the following detailed description are exemplary and explanatory and are intended to provide further explanation of the subject matter of invention, which is defined solely by the appended claims.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a flowchart schematically illustrating a method for providing a multi-level incentive for an online game according to first to third exemplary embodiments of the invention.

FIG. 2 is a schematic diagram of a method for providing a multi-level incentive for an online game according to the first exemplary embodiment of the invention.

FIG. 3 is a schematic diagram of a method for providing a multi-level incentive for an online game according to the second embodiment of the invention.

FIG. 4 is a schematic diagram of a system for providing a multi-level incentive for an online game according to an exemplary embodiment of the invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and apparatus are shown in block diagram form in order to avoid unnecessarily obscuring various exemplary embodiments.

In the accompanying figures, the size and relative sizes of regions, etc., may be exaggerated for clarity and descriptive purposes. Also, like reference numerals denote like elements.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element or layer, there are no intervening elements present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, and/or sections, these elements, components, regions, and/or sections should not be limited by these terms. These terms are used to distinguish one element, component, region, and/or section from another element, component, region, and/or section. Thus, a first element, component, region, and/or section discussed below could be termed a second element, component, region, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

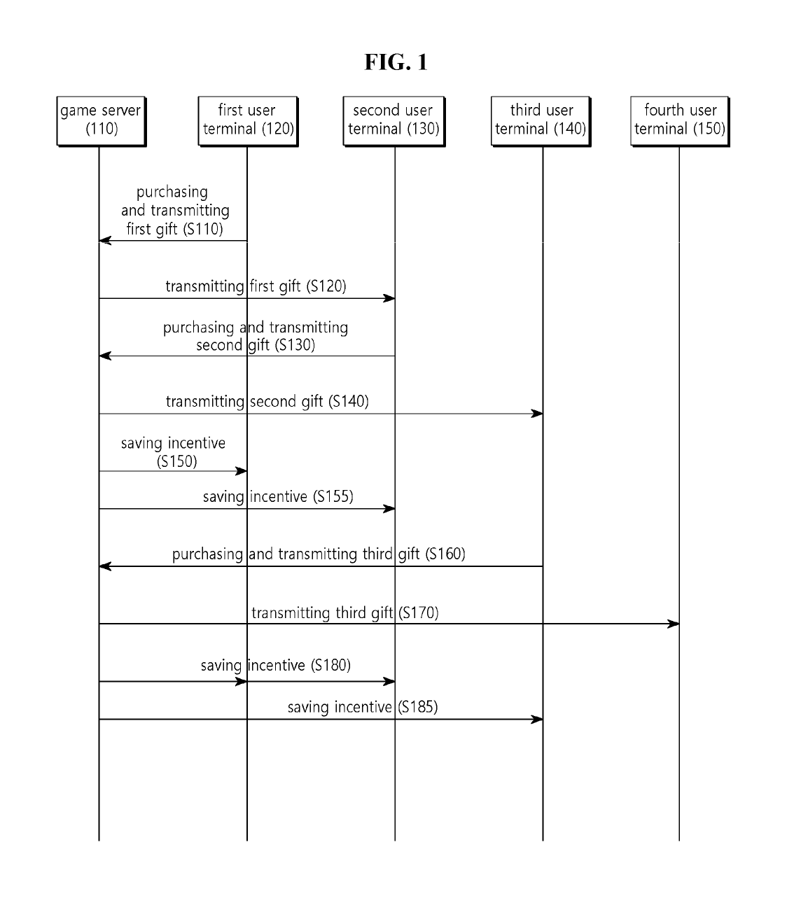

FIG. 1 is a flowchart schematically illustrating a method for providing a multi-level incentive for an online game according to first to third exemplary embodiments of the invention.

A method for providing a multi-level incentive for an online game according to exemplary embodiments of the invention will be described with reference to user terminals 120, 130, 140, and 150 and a game server 110. The user terminals may be a fixed or mobile computer, laptop, hand held, mobile phone or other device containing sufficient computer processing, memory and communication capabilities and software to participate in an online game. The terminal has a user account associated with user and the terminal for one or more online games. As used herein “terminal” may refer to the actual device or the user account associated with the terminal. The game server may be one or more computers with sufficient processing, memory and communication capabilities and software to host one or more online games. As used herein, various “requests” may refer to a signal transmitted between electronic devices or user accounts. At step S110, a game server 110 receives a first gift purchasing request and a transmission request to send the first gift to a second user terminal 130 from a first user terminal 120. At step S120, the purchase of the first gift is completed and the first gift is transmitted from the game server 110 to the second user terminal 130. At step S130, the game server 110 receives a second gift purchasing request and a transmission request to send the second gift to a third user terminal 140 from the second user terminal 130. At step S140, the purchase of the second gift is completed and the second gift is transmitted from the game server 110 to the third user terminal 140. At step S150, the game server 110 provides as a credit (saves) an incentive, such as a reward consisting of points or values associated with the online game, that corresponds to the purchase price of the first gift to the first user terminal 120. Alternatively, at step S130, the second user terminal 130 may transmit the second gift to the first user terminal 120.

In particular, when the first user terminal 120 purchases a game item at a monetary value, e.g., 1000 won ( [symbol] ), dollars or bit coin, through the game server 110 and transmits the game item to the second user terminal 130 registered as a friend of the first user terminal 120, and when the second user terminal 130 purchases a game item at [symbol] 1000 through the game server 110 and transmits the game item to the first user terminal 120 or the third user terminal 140 registered as a friend of the second user terminal 130, then the game server 110 saves a portion of the purchase price of the game item (i.e., [symbol] 1000), for example, 10% or [symbol] 100, to the first user terminal 120 as a reward credit, which can take the form of monetary value, game credits, points, frequent flier mileage, etc.

Next, at step S160, the game server 110 may receive a third gift purchasing request and a transmission request to send the third gift to a fourth user terminal 150 from the third user terminal 140. At step S170, the purchase of the third gift is completed and the third gift is transmitted from the game server 110 to the fourth user terminal 150. At step S180, the game server 110 saves a secondary incentive according to the purchase price of the first gift to the first user terminal 120 and an incentive according to the purchase price of the second gift to the second user terminal 130. Alternatively, at step S160, the third user terminal 140 may transmit the third gift to the second user terminal 130.

In particular, when the third user terminal 140 having received the second gift purchases a game item at a value of [symbol] 1000 through the game server 110 and transmits the game item to the second user terminal 130 or the fourth terminal 150 registered as a friend of the third user terminal 140, the game server 110 saves a portion of the purchase price of the game item (i.e., [symbol] 1000), for example, 10% or [symbol] 100, respectively to the first user terminal 120 (S150) and the second user terminal (S155) 130 as the reward credit.

In this manner, the first user terminal 120 earns [symbol] 200 by a single purchase of the game item as the reward credit, and the second user terminal 130 earns [symbol] 100 according to the purchase of the game item as the reward credit.

Similarly, the first user terminal 120, the second user terminal 130, and the third user terminal 140 may receive additional incentives when the fourth user terminal 150 purchases a gift and transmits the gift to the third user terminal or another user terminal registered as a friend of the fourth user terminal 150.

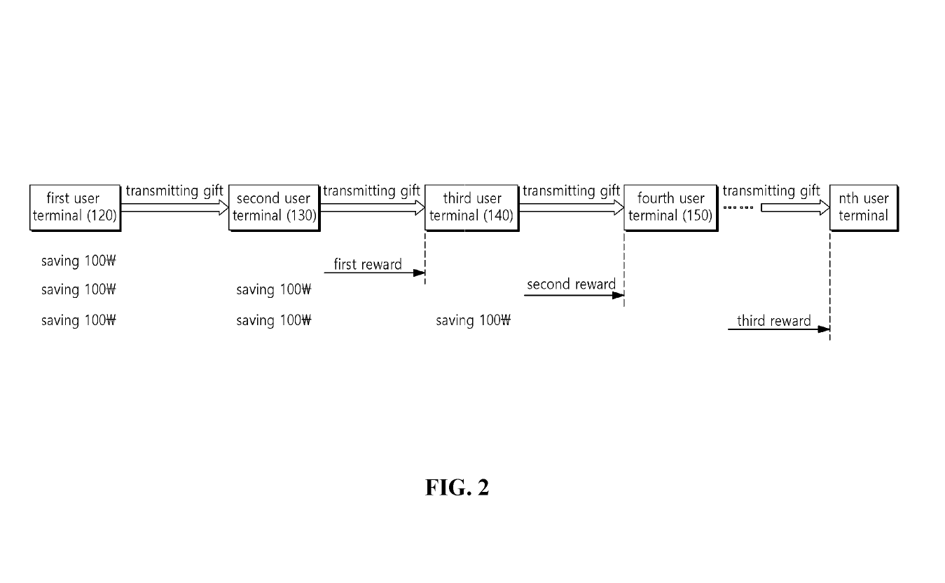

Referring to FIG. 2, when a first user of the first user terminal 120 purchases the first gift and transmits the first gift to a second user of the second user terminal 12 registered as a friend of the first user, and when the second user of the second user terminal 130 having received the first gift purchases a second gift and transmits the second gift to a third user of the third user terminal 140 registered as a friend of the second user, then, the game server 110 saves [symbol] 100 to the first user terminal 120 as a first reward (or incentive). Next, when the third user of the third user terminal 140 having received with the second gift purchases a third gift and transmits the third gift to a fourth user of the fourth user terminal 150 registered as a friend of the third user, then, the game server 110 saves [symbol] 100 to each of the first user terminal 120 and the second user terminal as a second reward. In this manner, when the fourth user of the fourth user terminal 150 purchases a gift and transmits the gift to an n^{th} user of an n^{th} user terminal, then, the game server 110 saves [symbol] 100 to each of the first user terminal 120 to third user terminal 140.

The reward method described above may save up to a certain percentage of the purchase price of the game item as the reward credit (for example, 300 [symbol] or 500 [symbol] , which are 30% and 50% of the purchase price, respectively). After the reward credit is accumulated to the certain percentage, the reward credit may not be saved any more, such that the saved reward credit does not exceed the certain percentage of the purchase price of the game item. The percentage may be varied depending on types of item, price, level, or level of the game user.

The game server 110 may save the incentive through a game-mailbox or a game-media capable of receiving goods.

The reward credit may be used to purchase game items, contents other than the game items, such as profile decoration, music, emoticons, and etc. When the reward credit is used to purchase game items or contents, all or a portion of the purchase price may be paid through the reward credit.

A method for providing a multi-level incentive according to the second exemplary embodiment is substantially the same as the first embodiment, however, the method further includes, a step S155 of saving an incentive to the second user terminal 130 according to the purchase price of the second gift after step S150, and a step S185 of saving an incentive to the third user terminal 140 according to the purchase price of the third gift after step S180.

More particularly, when the first user terminal 120 purchases a game item at [symbol] 1000 through the game server 110 and transmits the game item to the second user terminal 130, and when the second user terminal 130 purchases a game item at [symbol] 1000 through the game server 110 and transmits the game item to the first user terminal 120 or the third user terminal 140, then, the game server 110 saves a portion of the purchase price, such as [symbol] 100, to each the first user terminal 120 and the second user terminal 130 as a reward credit.

Next, when the third user terminal 140 purchases a game item at [symbol] 1000 through the game server 110 and transmits the game item to the second user terminal 130 or the fourth user terminal 150, then, the game server 110 saves a portion of the purchase price [symbol] 1000, such as [symbol] 100, to each the first user terminal 120, the second user terminal 130, and the third user terminal 140 as a reward credit.

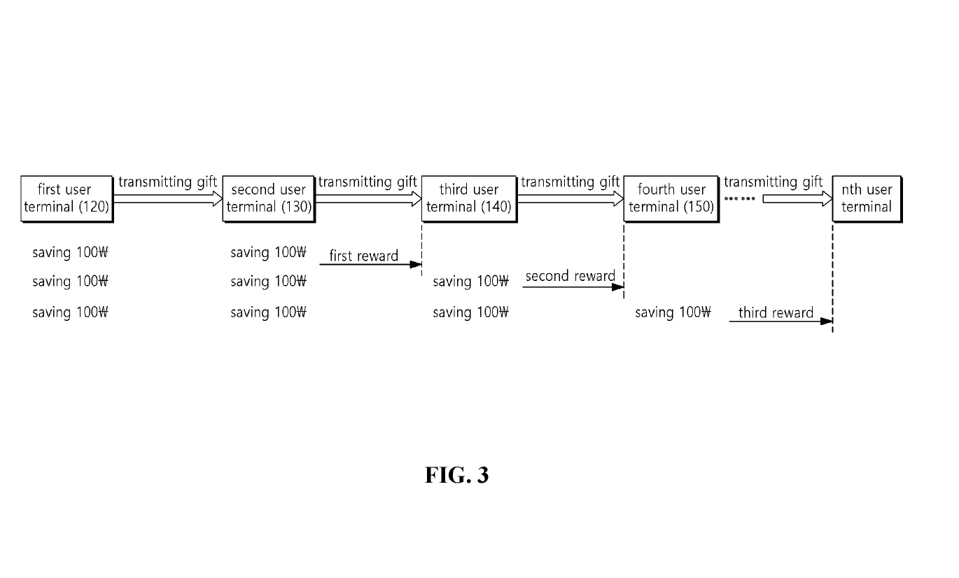

Referring to FIG. 3, when a first user of the first user terminal 120 purchases the first gift and transmits the first gift to a second user of the second user terminal 12 registered as a friend of the first user terminal 120, and when the second user of the second user terminal 130 having received the first gift purchases the second gift and transmits the second gift to a third user of the third user terminal 140 registered as a friend of the second user terminal 130, then, the game server 110 saves [symbol] 100 to each of the first user terminal 120 and the second user terminal 130 as a first reward. Next, when the third user of the third user terminal 140 having received with the second gift purchases a third gift and transmits the third gift to a fourth user of the fourth user terminal 150 registered as a friend of the third user terminal 130, then, the game server 110 saves [symbol] 100 to each of the first user terminal 120 to the third user terminal 140 as a second reward. In this manner, when the fourth user of the fourth user terminal 150 purchases a gift and transmits the gift to an n^{th} user of an n^{th} user terminal, then, the game server 110 saves [symbol] 100 to the first user terminal 120 to the fourth user terminal 150, respectively.

A method for providing a multi-level incentive according to the third exemplary embodiment is substantially the same as the first exemplary embodiment, however, the method further includes a step S145 of determining whether the third user of the third user terminal 140 is registered as a friend of the first user of the first user terminal 120 before the step S150, and a step S175 of determining if the fourth user of the fourth user terminal 150 is registered as friends of the first user of the first user terminal 120 and the second user of the second user terminal 130 before the step S180.

More particularly, when the first user terminal 120 purchases a game item at [symbol] 1000 through the game server 110 and transmits the game item to the second user terminal 130 registered as a friend of the first user terminal 120, and when the second user terminal 130 purchases a game item at [symbol] 1000 through the game server 110 and transmits the game item to the first user terminal 120 or the third user terminal 140 registered as a friend of the second user, then, the game server 110 determines whether the third user of the third user terminal 140 is a friend of the first user of the first user terminal 120, and if so, saves a portion of the purchase price of the [symbol] 1000 to the first user terminal 120 as a reward credit.

More particularly, when the first user of the first user terminal 120 purchases the first gift and transmits the first gift to the second user of the second user terminal 130 registered as a friend of the first user terminal 120, and the second user of the second user terminal 130 having received with the first gift purchases the second gift and transmits the second gift to the third user of the third user terminal 140 registered as a friend of the second user terminal 130, then, the game server 110 determines whether the first user of the first user terminal 120 and the third user of the third user terminal 140 are mutually registered as friends. If so, the game server 110 saves [symbol] 100 to the first user terminal 120 as the reward credit.

Next, when the third user terminal 120 purchases a game item at [symbol] 1000 through the game server 110 and transmits the game item to the fourth user terminal 150 registered as a friend of the third user terminal 120, then, the game server 110 determines whether the fourth user of the fourth user terminal 150 is registered as a friend of the first user of the first user terminal 120 and the second user of the second user terminal 130. If so, the game server 100 saves the portion of the purchase price of [symbol] 1000 [symbol] , such as 10% or [symbol] 100, to the first user terminal 120 and the second user terminal 130, respectively.

More particularly, when the third user of the third user terminal 140 purchases the third gift and transmits the third gift to the fourth user of the fourth user terminal 150 registered as a friend of the third user terminal 140, then, the game server 110 determines whether the first user of the first user terminal 120 and the second user of the second user terminal 130 are registered as friends of the third user of the third user terminal 130. If so, the game server 110 saves [symbol] 100 to each of the first user terminal 120 and the second user terminal 130 as the reward credit.

The game server 110 may determine whether one user terminal is registered as a friend of another user terminal based on friend lists stored in the game server 110, and the friend list of the first user may be included in an address book of the first user terminal 120, the friend list of the second user may be included in an address book of the second user terminal 130, and the like. Alternatively, the friends lists may be based upon other social media sites, such as Facebook, or stored in the cloud.

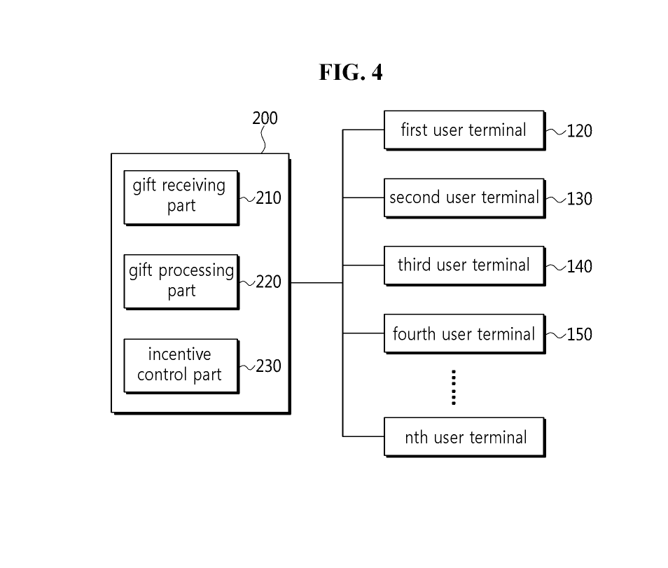

FIG. 4 is a schematic diagram of a system for providing a multi-level incentive according to an exemplary embodiment of the invention.

A system 200 for providing a multi-level incentive for an online game according to an exemplary embodiment of the invention includes a processor or software module having sub-modules including a gift receiving module 210, a gift processing module 220, and an incentive controlling module 230. The gift receiving module 210 may receive gift transmissions of a first gift and a second gift. The gift transmission processing module 220 may process the transmission of the first gift and the second gift. The incentive controlling module 230 may provide an incentive according to the transmissions and values of the first gift and the second gift. More particularly, the incentive controlling module 230 provides the incentive when the first gift transmission is associated with sending a first gift to a second user terminal 130 by a first user terminal 120, and when the second gift transmission is associated with sending a second gift to a third user terminal 140 by the second user terminal 130. The second user terminal 130 may alternatively transmit the gift to the first user terminal 120 registered as a friend of the second user terminal 130.

The incentive controlling module 230 saves a certain percentage of a purchase price of the first gift to the first user terminal 120 as a reward credit. For example, when the first user terminal 120 purchases the gift at [symbol] 1000, then, 10% or [symbol] 100, for example, may be saved as the reward credit.

Alternatively, the incentive controlling module 230 may save a certain percentage of a purchase price of the first gift to the first user terminal 120 and a certain percentage of a purchase price of the second gift to the second user terminal 130 as a reward credit. For example, when the first user terminal 120 purchases the gift at [symbol] 1000 and the second user terminal 120 purchases the gift at [symbol] 1000, then, 10% or [symbol] 100 may be saved to each of the first user terminal 120 and the second user terminal 130 as the reward credit.

Alternatively, the incentive controlling module 230 includes a friend list controlling module (not shown), which stores friend lists included in an address book of the user terminals. The incentive controlling module saves a certain percentage of a purchase price of the first gift to the first user terminal 120 as a reward credit when a third user of the third user terminal 140 is stored in the address book (e.g., registered as a friend) of the a first user of the first user terminal 120. For example, when the first user terminal 120 purchases the gift at [symbol] 1000, then, 10% or [symbol] 100, for example, may be saved as the reward credit.

Next, the gift receiving module 210 receives gift transmissions of a third gift from a third user terminal 150, the gift transmission processing module 220 performs the third gift transmission, and the incentive controlling module 230 provides an incentive according to a purchase price of the third gift, when the third gift transmission is associated with sending the third gift to a fourth user terminal 150 registered as a friend of the third user terminal 150. The third user terminal 140 may alternatively transmit the third gift to the second user terminal 130.

The incentive controlling module 230 may save a certain percentage of a purchase price of the first gift to the first user terminal 120 as a reward credit, and a certain percentage of a purchase price of the second gift to the second user terminal 130 as a reward credit. For example, when the first user terminal 120 purchases the gift at [symbol] 1000 and the second user terminal 120 purchases the gift at [symbol] 1000, then, 10% or [symbol] 100, for example, may be saved to each of the first user terminal 120 and the second user terminal 130 as the reward credit.

Alternatively, the incentive controlling module 230 may each save a certain percentage of a purchase price of the first gift to the first user terminal 120, a certain percentage of a purchase price of the second gift to the second user terminal 130, and a certain percentage of a purchase price of the third gift to the third user terminal 140 as a reward credit. For example, when the first user terminal 120 purchases the gift at [symbol] 1000, the second user terminal 120 purchases the gift at [symbol] 1000, and the third user terminal 140 purchases the gift at [symbol] 1000, then, 10% or [symbol] 100, for example, may be saved to each of the first user terminal 120 to the third user terminal 140 as the reward credit.

Alternatively, the incentive controlling module 230 may save a certain percentage of a purchase price of the first gift to the first user terminal 120 and a certain percentage of a purchase price of the second gift to the second user terminal 130 as a reward credit, when the third user of the third user terminal 140 registered as a friend in the friend list of the first user of the first user terminal 120 and in the friend list of the second user of the second user terminal 130. For example, when the first user terminal 120 purchases the gift at [symbol] 1000 and the second user terminal 120 purchases the gift at [symbol] 1000, then, 10% or [symbol] 100, for example, may be saved to each of the first user terminal 120 and the second user terminal 130 as the reward credit.

In this manner, when the gift receiving module 210 receives gift transmissions of an n^{th} gift, the gift transmission processing module 220 performs the n^{th} gift transmission, and the incentive controlling module 230 provides an incentive according to a purchase price of the n^{th} gift, when the n^{th} gift transmission from the n^{th} user terminal 140 is associated with sending the n^{th} gift to a (n+1)^{th} user terminal registered as a friend of the n^{th} user terminal.

The incentive controlling module 230 may save up to certain percentage of the purchase price of the game item (for example, [symbol] 300 or [symbol] 500, which are 30% and 50% of the price, respectively) as the reward credit, and after the certain percentage, the reward credit may not be saved any more. The ceiling percentage may be varied depending on types of item, price, level, or level of the game user.

The incentive controlling module 230 may save the incentive to a game-mailbox or a game-media capable of receiving goods.

The reward credit may be utilized to purchase game items and contents other than the game items, such as profile decorations, music, emoticons, bit coin, and etc. When the reward credit is used to purchase game items or content, all or partial of the purchase price may be paid through the reward credit.

Although certain exemplary embodiments and implementations have been described herein, other embodiments and modifications will be apparent from this description. Accordingly, the inventive concepts are not limited to such exemplary embodiments, but rather only by the scope of the appended claims and various modifications and equivalent arrangements apparent to skilled artisan.

What is claimed is:

1. A method for improving the performance of an online game by providing an incentive to one or more user terminals used in the online game upon obtaining a gift from a game server, the method comprising:
receiving from a first user terminal a first gift request and a transmission request to send the first gift to a second user terminal;
processing the first gift request and transmitting the first gift to the second user terminal;
receiving from the second user terminal a second gift request and a transmission request to send the second gift to the first user terminal or a third user terminal;
processing the second gift request and transmitting the second gift to the first user terminal or the third user terminal; and
providing a first incentive corresponding to a characteristic of the first gift to the first user terminal.

2. The method of claim 1, further comprising:
providing the first incentive corresponding to a characteristic of the second gift to the second user terminal.

3. The method of claim 1, further comprising:
receiving from the third user terminal a third gift request and a transmission request to send the third gift to the second user terminal or a fourth user terminal;
processing the third gift request and transmitting the third gift to the second user terminal or the fourth user terminal; and
providing a second incentive corresponding to the characteristic of the first gift to the first user terminal and the first incentive corresponding to a characteristic of the second gift to the second user terminal.

4. The method of claim 3, further comprising:
providing the first incentive corresponding to a characteristic of the third gift to the third user terminal.

5. The method of claim 1, wherein the incentive is provided to a game-mailbox or a game-media capable of receiving items associated with a user account.

6. The method of claim 1, wherein the incentive corresponds to a portion of the values of the gift obtained and is saved as a reward credit.

7. The method of claim 6, wherein the saved reward credit does not exceed a first percentage of the value of the gift.

8. The method of claim 6, wherein the reward credit is capable of being used to obtain items or join an online event hosted by the game server.

9. The method of claim 8, wherein the reward credit is capable of being used to obtain a portion of the value of the items.

10. An online gaming system for providing an incentive to one or more user terminals connected to a game server, the system comprising:
a gift receiving module configured to receive requests to transmit a first gift and a second gift to user terminals;
a gift transmission processing module configured to process the requests to transmit the first gift and the second gift; and
an incentive controlling module configured to provide an incentive in response to transmitting the first gift and the second gift when the first gift is obtained by a first user terminal and transmitted to a second user terminal, and the second gift is obtained by the second user terminal and transmitted to a third user terminal.

11. The system of claim 10, wherein the incentive controlling module is configured to save a first reward credit based upon a portion of the values of the first gift to the first user terminal.

12. The system of claim 10, wherein the incentive controlling module is configured to save:
a portion of the value of the first gift to the first user terminal as a first reward credit; and
a portion of the value of the second gift to the second user terminal as the first reward credit.

13. The system of claim 10, wherein:
the incentive controlling module comprises a friend list controlling module configured to store friends lists stored in an address book of the user terminals; and
the incentive controlling module is configured to save a portion of the value of the first gift to the first user terminal as a first reward credit, when a third user of the third user terminal is stored in the address book of the first user terminal.

14. The system of claim 11, wherein:
the gift receiving module is configured to receive a request to transmits a third gift;
the gift transmission processing module is configured to process the request and transmit the third gift; and
the incentive controlling module is configured to provide the incentive corresponding to a characteristic of the third gift to the user terminals upon transmitting the third gift, when the third gift is obtained by the third user terminal and transmitted to the second user terminal or a fourth user terminal.

15. The system of claim 14, wherein the incentive controlling module is configured to save:
a portion of the value of the first gift to the first user terminal as a second reward credit; and
a portion of the value of the second gift to the second user terminal as the first reward credit.

16. The system of claim 12, wherein:
the gift receiving module is configured to receive a request to send a third gift;
the gift transmission processing module is configured to process the request and transmit the third gift; and
the incentive controlling module is configured to provide:
a portion of the value of the first gift to the first user terminal as a second reward credit;
a portion of the value of the second gift to the second user terminal as the second reward credit; and
a portion of a value of the third gift to the third user terminal as the first reward credit, when the third gift is obtained by the third user terminal and transmitted to the second user terminal or a fourth user terminal.

17. The system of claim 13, wherein:
the gift receiving module is configured to receive a request to send a third gift;
the gift transmission processing module is configured to process the request and transmit the third gift to a fourth user terminal; and
the incentive controlling module is configured to provide:
a portion of the value of the first gift to the first user terminal as a second reward credit; and
a portion of the value of the second gift to the second user terminal as the first reward credit, when a fourth user of the fourth user terminal is stored in the address book of the first user terminal and in the address book of the second user terminal.

18. The system of claim 10, wherein the incentive is provided to a game-mailbox or a game-media capable of receiving items associated with a user account.

19. The system of claim 17, wherein the saved reward credit does not exceed a first percentage of the value of the gift.

20. The system of claim 19, wherein the reward credit is capable of being used to obtain items or join an online event hosted by the game server.

21. The system of claim 20, wherein the reward credit is capable of being used to obtain pay only a portion of the value of the items.

22. A method for improving the performance of an online game by providing an incentive to one or more user terminals used in the online game upon obtaining a gift from a game server, the method comprising:
receiving from a first user terminal a first gift request and a transmission request to send the first gift to a second user terminal;
processing the first gift request and transmitting the first gift to the second user terminal;
receiving from the second user terminal a second gift request and a transmission request to send the second gift to a third user terminal;
processing the second gift request and transmitting the second gift to the third user terminal;
determining in a processor of the game server whether a third user of the third user terminal is registered as a friend of a first user of the first user terminal;
providing the incentive corresponding to a characteristic of the first gift to the first user terminal as a first reward credit when the third user of the third user terminal is registered as a friend of the first user of the first user terminal.

23. The method of claim 22, wherein determining of the third user as the friend of the first user is based on a friend list of the first user.

24. The method of claim 23, wherein the friend list of the first user comprises at least one friend stored in an address book of the first user terminal.

25. The method of claim 22, wherein the incentive is provided to a game-mailbox or a game-media capable of receiving items associated with a user account.

26. The method of claim 22, wherein the incentive corresponds a portion of the value of the gift and is saved as a reward credit.

27. The method of claim 26, wherein the saved reward credit does not exceed a first percentage of the value of the gift.

28. The method of claim 26, wherein the reward credit is capable of being used to obtain items or join an online event hosted by the game server.

29. The method of claim 28, wherein the reward credit is capable of being used to obtain a portion of the value of the items.

30. The method of claim 22, further comprising:
receiving from the third user terminal a third gift request and a transmission request to send the third gift to a fourth user terminal;
transmitting the third gift to the fourth user terminal;
determining whether a fourth user of the fourth user terminal is registered as a friend of the first user of the first user terminal and a second user of the first user terminal;
providing a portion of the value of the first gift to the first user terminal as a second reward credit, and a portion of the value of the second gift to the second user terminal as the first reward credit, if the fourth user of the third user terminal is registered as a friend of the first user of the first user terminal and the second user of the second user terminal.

31. The method of claim 30, wherein determining of the fourth user of the fourth user terminal as a friend of the first user and the second user is based on friend lists of the first user and the second user stored in the game server.

32. The method of claim 31, wherein:
a friend list of the first user comprises at least one friend stored in an address book of the first user terminal; and
a friend list of the second user comprises at least one friend stored in an address book of the second user terminal.
